(19) United States
(12) Patent Application Publication
(10) Pub. No.: US 2013/0215801 A1
(43) Pub. Date: Aug. 22, 2013

(54) TIME VARYING CHANNELS HAVING PILOTS

(71) Applicants: Huiheng Mai, Wokingham (GB); Paul Howard, Bristol (GB); Alan Edward Jones, Wiltshire (GB)

(72) Inventors: Huiheng Mai, Wokingham (GB); Paul Howard, Bristol (GB); Alan Edward Jones, Wiltshire (GB)

(73) Assignee: INTELLECTUAL VENTURES HOLDING 81 LLC, Las Vegas, NV (US)

(21) Appl. No.: 13/810,649

(22) PCT Filed: Jul. 19, 2011
(86) PCT No.: PCT/EP2011/062382

§ 371 Date: May 6, 2013

(30) Foreign Application Priority Data
Jul. 19, 2010 (GB) 1012073.1

(51) Int. Cl. H04J 3/02

(52) U.S. Cl. CPC H04J 3/02
USPC 370/280

(57) ABSTRACT

A wireless communication unit for recovering transmit data comprises a receiver for receiving a signal comprising a data payload and at least two pilots, wherein at least a first pilot type of the at least two pilots is different to a second pilot type of the at least two pilots. The wireless communication unit further comprises a processor arranged to: extract at least one pilot of the first pilot type from the received signal; and recover the data payload from the received signal using the extracted at least one pilot of the first pilot type.

### FIELD OF THE INVENTION

The field of this invention relates to a communication unit and a hybrid method of employing a pilot signal in time-varying communication channels, particularly in cellular communication systems.

### BACKGROUND OF THE INVENTION

Currently, 3rd generation cellular communication systems are being rolled out to further enhance the communication services provided to mobile phone users. The most widely adopted 3rd generation communication systems are based on Code Division Multiple Access (CDMA) and Frequency Division Duplex (FDD) or Time Division Duplex (TDD) technology. In CDMA systems, user separation is obtained by allocating different spreading and/or scrambling codes to different users on the same carrier frequency and in the same time intervals. This is in contrast to time division multiple access (TDMA) systems, where user separation is achieved by assigning different time slots to different users.

In addition, TDD provides for the same carrier frequency to be used for both uplink transmissions, i.e. transmissions from the mobile wireless communication unit (often referred to as wireless subscriber communication unit) to the communication infrastructure via a wireless serving base station and downlink transmissions, i.e. transmissions from the communication infrastructure to the mobile wireless communication unit via a serving base station. In TDD, the carrier frequency is subdivided in the time domain into a series of timeslots. The single carrier frequency is assigned to uplink transmissions during some timeslots and to downlink transmissions during other timeslots. An example of a communication system using this principle is the Universal Mobile Telecommunication System (UMTS). Further description of CDMA, and specifically of the Wideband CDMA (VVCDMA) mode of UMTS, can be found in ‘WCDMA for UMTS’, Harri Holma (editor), Antti Toskala (Editor), Wiley & Sons, 2001, ISBN 0471486876.

In a conventional cellular system, cells in close proximity to each other are allocated non-overlapping transmission resources. For example, in a CDMA network, cells within close proximity to each other are allocated distinct spreading codes (to be used in both the uplink direction and the downlink direction). This may be achieved by, for example, employing the same spreading codes at each cell, but a different cell specific scrambling code. The combination of these leads to effectively distinct spreading codes at each cell.

Referring now to FIG. 1, the physical communication channels in 3GPP TDD-CDMA communication systems are transmitted over the air by one of the four defined types of burst structures 155, 160, 165, 170, which share a generic structure 100. The generic structure of the different types of burst 150 comprises of three different fields:

(i) first and second data fields 105, 115 that comprise respective first and second data symbols 125, 140, and are used to carry data and control channels. Spreading may be used on the data symbols in each data field, depending on the spreading factor configuration.

(ii) a midamble sequence 110 that comprises a cyclic prefix 130 and a base sequence 135, where the midamble sequence 110 is used to provide references for channel estimation and also possibly for signalling active spreading codes; and

(iii) a guard period 120 is to allow for switching between uplink (UL) and downlink (DL) transmissions.

In 3GPP TDD-CDMA, each of the different burst structure types 155, 160, 165, 170 employs a different combination of field lengths, as shown in FIG. 1. In 3GPP TDD-CDMA, multiple midambles and multiple codes can be used in a single time slot. For certain midamble allocation schemes, a mapping exists between particular midambles and spreading codes. Thus, at the receiver and based on this known mapping, the receiver is able to first determine, from processing received signals, those midamble sequences 110 that are present and are being used in the received signal and derive there from which spreading codes are active.

The base sequence 135 of the midamble sequence 110 is designed with good cyclic auto correlation, such that the shape of the cyclic autocorrelation typically appears like a delta function, i.e. a strong correlation with zero delay and weak or no correlation with non-zero cyclic delays. This allows the base sequence to be used as a reference signal for a channel that is likely to be subject to multipath effects, such as found in a 3GPP TDD-CDMA system. Reference signals for different user equipment (UE) or transmit antennas in Multiple-Input-Multiple-Output (MIMO) transmission can also be provided by different cyclically shifted version of the base sequences. The CP 130 is a replica of the last section of the base sequence 135. The CP 130 provides protection of the data content in the first data field 105 and accommodates possible timing control inaccuracy.

It is known that the midamble length (i.e. the number of symbol periods that is used up by the midamble sequence 135) may consume a significant portion of the total burst, for example 20% for the case of burst type-1 155. In addition, in order to provide processing gain, the main reason for such a long sequence length is due to the necessity to provide good correlation characteristics for scenarios with multipath, multiple UE and transmit antennas. In 3GPP TDD-CDMA, only a single midamble is provided within each burst 100. Consequently, the channel has to be substantially ‘stationary’ across the burst. For the vast majority of situations, where the UE is moving at a relatively slow speed, and therefore the channel remains reasonably constant across the burst, the burst structure with a single midamble sequence 135 as described is acceptable. However, the usefulness of the burst structure is severely limited in high speed scenarios. It should be noted that this problem or limitation also exists in other communication systems, such as TD-SCDMA, global system for mobile communications (GSM), Enhanced Data Rates for GSM Evolution (EDGE) and long-term evolution (LTE) uplink channels and many more communication systems, due to similar types of ‘burst’ structures being employed.

In many cellular communication systems, particular CDMA cellular systems, pilot symbols on a pilot channel are used to synchronise a UE with a Node B's transmission. In wideband CDMA (WCDMA) FDD, the CPICH is a downlink channel that is broadcast by Node Bs with constant power and of a known bit sequence. The CPICH power is usually between 5% and 15% of the total Node B transmit power. The Primary Common Pilot Channel is used by the UEs to first complete identification of a Primary Scrambling Code that is used for scrambling Primary Common Control Physical Channel (P-CCPCH) transmissions from the Node B. Later CPICH channels allow phase and power estimations to be made, as well as aiding discovery of other radio paths.

A pilot scheme that is designed for a time-varying channel inevitably needs to provide continuous time sampling of the channel. This is usually achieved by distributing pilots during the transmission period. The maximum pilot spacing (i.e. time between sampling points) is dictated by the Nyquist sampling theorem, which in essence stipulates a maximum pilot spacing relationship to correctly sample a time-varying signal. At each individual pilot sampling point, the pilots may have different correlation requirements, depending upon the transmission scheme (e.g. whether Single-Input-Single-Output (SISO) or MIMO transmission is used) and the channel frequency selectivity.

The classical Pilot-Symbol-Assisted-Modulation (PSAM) (J. K. Cavers, “An analysis of pilot symbol assisted modulation for Rayleigh fading channels”, IEEE Trans. Veh. Technol. Vol. 40, pp. 686-693, November 1991) technique is a simple case targeted for flat-fading, SISO channel, where typically a single pilot symbol is used at each sampling point. In PSAM, uniformly spaced pilot symbols are transmitted among the data symbols and the channel estimates are derived from nearby pilot symbols. As there is only a single pilot symbol at each sampling point, only a small pilot overhead is required. However, one drawback of such a single pilot symbol PSAM technique is that it does not work when the channel is frequency selective, when there are multiple transmits antennas, or when there are multiple UEs.

For these more complex deployment scenarios, the pilot at each sampling point needs to be equipped with good correlation characteristics, in order to minimise interference effects. In additional the pilot may include a CP when the channel is frequency selective. There are two aspects to the correlation characteristics requirement, namely: auto-correlation of the same pilot, and cross-correlation amongst different pilots. A good auto-correlation characteristic may be considered as a strong correlation with zero delay and weak or no correlation with non-zero delays. A good cross-correlation characteristic may be considered as weak or no correlation amongst different pilots with and/or without delay. The aforementioned ‘delay’ also encompasses a case with a cyclic delay.

Different deployment scenarios may have different requirements on correlation. For example, for a frequency-selective single input-single output (SISO) channel, the pilot should have good auto-correlation characteristics. For a frequency-selective, multiple input-multiple output (MIMO) or multiple-user channel, the pilot should not only have good auto-correlation, but also good cross-correlation between pilots from different antennas or users. For a frequency-flat fading MIMO channel, the pilots from different antennas should have good cross-correlation. These correlation requirements lead to a need for a pilot sequence (instead of a single symbol) to be used at the individual sampling point for these scenarios.

An example for frequency-selective SISO channels, where cyclic delayed orthogonal (e.g. zeros auto-correlation with non-zero delay) sequences with a CP are used at each pilot sampling point, is described in the publication titled ‘Digital communication receivers: synchronisation, channel estimation and signal processing’ authored by H. Meyr, M. Moeneclaey, and S. A. Fechtel and published by John Wiley and Sons Inc, 1997.

Another known example for flat-fading MIMO channels, where orthogonal (e.g. perfect cross-correlation) sequences with length equal to the number of transmit antennas are assigned at the each sampling point, is described in the publication titled “A space time coding modem for high-data-rate wireless communications”, authored by A. F. Naguib, V. Tarokh, N. Seshadr, and A. R. Calderbank, and published in IEEE J. Select. Areas Commun., vol. 16, pp. 1459-1478, October 1998.

Thus, the use of pilot sequences with good correlation characteristics may help solve the problem of signal source separation. However, a significant problem with this technique is that the pilot overhead can be increased noticeably, as the pilot length at each sampling point may increase significantly to achieve good correlation characteristics. The pilot length normally increases as the length of the channel delay profile, and the number of transmit antennas and/or users.

A conventional way to extend the existing TD-CDMA burst structure, particularly for high speed scenarios, would be to distribute multiple copies of the midamble sequence in a burst to provide more time sampling, i.e. a higher sampling frequency, as illustrated in FIG. 2.

Referring now to FIG. 2, a known modified structure of a TDD-CDMA burst 200 comprises a single data fields 205 that comprises respective data symbols 225 used to carry data and control channels; first and second midamble sequences 210, 240 that comprises a cyclic prefix 230 and a base sequence 235, where the midamble sequence 210 is used to provide references for channel estimation and also possibly for signalling active spreading codes; and a guard period 220 that allows for switching between uplink (UL) and downlink (DL) transmissions. Thus, two sampling points using the two midamble sequences 210, 240 are provided for in the known modified TDD-CDMA burst 200. Although such a technique improves the performance in time-varying channels, it does, however, require an extremely high pilot overhead, even for a few sampling points. The high pilot overhead is due to the fact that the midamble sequence itself is already relatively long, for example, the overhead ratios would typically be of the order of 40% of the burst length for two sampling points or 60% of the burst length for three sampling points of the burst type-1 respectively, which clearly does not leave much room for data transmission.

Referring now to FIG. 3, a known receiver architecture 300 is illustrated that is capable of detecting pilot symbols in accordance with the TDD-CDMA burst structures of FIG. 1 or FIG. 2. The known receiver architecture 300 comprises a received signal 305 being input to a detector 315 and a channel estimator 310. The channel estimator then provides channel estimation values to the detector 315 to facilitate detection of the received signal 305 in producing detected symbols 320.

Consequently, current techniques using either single or multiple midamble sequences are suboptimal. Hence, an improved mechanism to address the problem of supporting pilot signal transmissions over a cellular network would be advantageous. In particular, a system allowing pilot signal transmissions over a time-varying communication channel, as is typical in TDD-CDMA cellular networks would be advantageous.

### SUMMARY OF THE INVENTION

Accordingly, the invention seeks to mitigate, alleviate or eliminate one or more of the abovementioned disadvantages singly or in any combination.

According to aspects of the invention, there is provided, a receiving wireless communication, an integrated circuit therefor, an associated method and tangible computer program product as well as a transmitting wireless communication, an integrated circuit therefor, an associated method and tangible computer program product, as described in the appended claims.

These and other aspects, features and advantages of the invention will be apparent from, and elucidated with reference to, the embodiment(s) described hereinafter.

### BRIEF DESCRIPTION OF THE DRAWINGS

Embodiments of the invention will be described, by way of example only, with reference to the accompanying drawings, in which:

FIG. 1 illustrates a known generic TDD-CDMA burst structure;

FIG. 2 illustrates a known example of a conventional way to modify a TDD-CDMA burst using two pilot sampling points;

FIG. 3 illustrates a known simplified receiver architecture;

FIG. 4 illustrates an example of a 3GPP cellular communication system;

FIG. 5 illustrates an example of a wireless communication unit, such as a user equipment (UE) or a NodeB;

FIG. 6 illustrates an example of a TDD-CDMA burst structure employing one example of a proposed pilot technique, where three pilot symbols per data field are employed;

FIG. 7 illustrates an example block diagram of a receiver employing an example of a hybrid pilot method;

FIG. 8 illustrates an example of a transmitter flowchart;

FIG. 9 illustrates an example of a receiver flowchart;

FIG. 10 illustrates the current LTE slot structure;

FIG. 11 illustrates an example of an extended LTE slot structure employing one example of a proposed pilot technique; and

FIG. 12 illustrates a typical computing system that may be employed to implement signal processing functionality in embodiments of the invention.

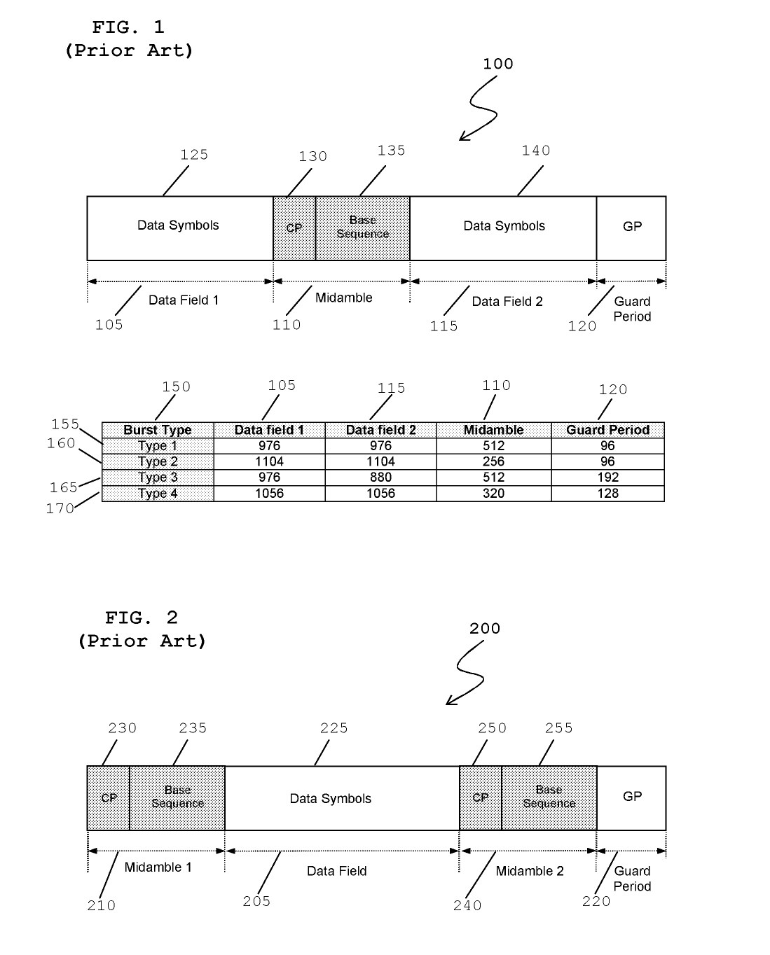

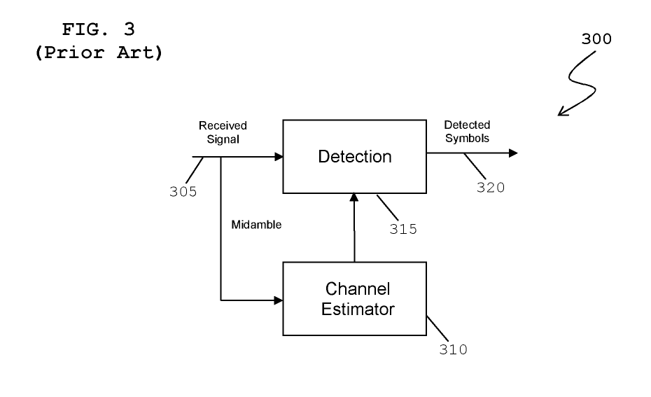

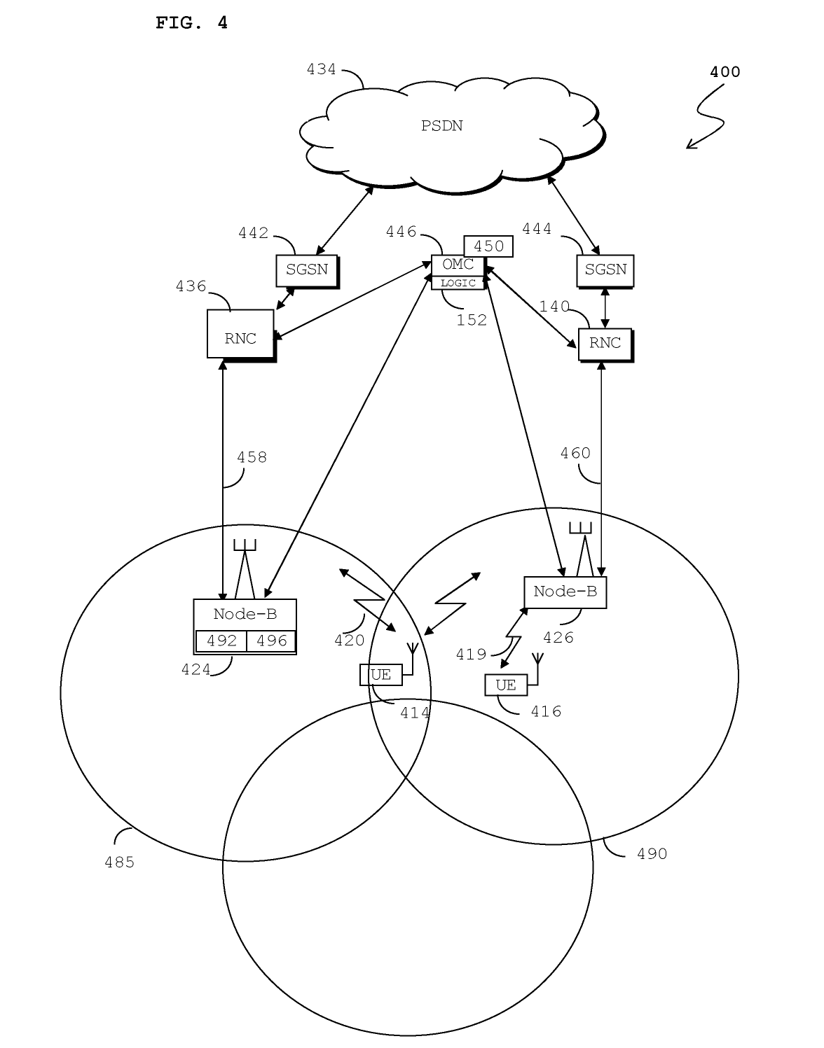

### DETAILED DESCRIPTION

The following description focuses on embodiments of the invention applicable to a UMTS™ (Universal Mobile Telecommunication System) cellular communication system and in particular to a UMTS Terrestrial Radio Access Network (UTRAN) operating in a Time Division Duplex (TDD)-code division multiple access (CDMA) mode within a 3^{rd} generation partnership project (3GPP™) system, such as TD-CDMA and time-division synchronous code-division multiple access (TD-SCDMA) standards relating to the UTRAN radio Interface (described in the 3GPP™ TS 25.xxx series of specifications). However, it will be appreciated that the invention is not limited to this particular cellular communication system, but may be applied to other any wireless communication system using a time-varying channel, for example a global system for mobile (GSM) communication system, an Enhanced Data Rates for GSM Evolution (EDGE) communication system, an uplink channel on a long-term evolution (LTE) communication system, etc.

Referring now to FIG. 4, a cellular-based communication system 400 is shown in outline, in accordance with one embodiment of the present invention. In this embodiment, the cellular-based communication system 400 is compliant with, and contains network elements capable of operating over, a TDD-CDMA air-interface. A plurality of wireless subscriber communication units/terminals (or user equipment (UE) in UMTS nomenclature) 414, 416 communicate over radio links 419, 420 with a plurality of base transceiver stations, referred to under UMTS terminology as Node-Bs, 424, 426. The cellular-based communication system comprises many other UEs and Node-Bs, which for clarity purposes are not shown. The wireless communication system, sometimes referred to as a Network Operator's Network Domain, is connected to an external network 434, for example the Internet. The Network Operator's Network Domain includes:

(i) A core network, comprising at least one Gateway General Packet Radio System (GPRS) Support Node (GGSN) (not shown) and at least one Serving GPRS Support Nodes (SGSN) 442, 444; and

(ii) An access network, comprising a plurality of UMTS Radio network controllers (RNCs) 436, 440; and a plurality of UMTS Node-Bs (base stations) 424, 426.

The GGSN (not shown) or SGSN 442, 444 is responsible for UMTS interfacing with a Public network, for example a Public Switched Data Network (PSDN) (such as the Internet) 434 or a Public Switched Telephone Network (PSTN). The SGSN 442, 444 performs a routing and tunnelling function for traffic, whilst a GGSN links to external packet networks. The Node-Bs 424, 426 are connected to external networks, through Radio Network Controller stations (RNC), including the RNCs 436, 440 and mobile switching centres (MSCs), such as SGSN 444. A cellular communication system will typically have a large number of such infrastructure elements where, for clarity purposes, only a limited number are shown in FIG. 4.

Each Node-B 424, 426 contains one or more transceiver units and communicates with the rest of the cell-based system infrastructure via an I_{ub} interface, as defined in the UMTS specification. Node-B 424 supports communication over geographic area 485 and Node-B 426 supports communication over geographic area 490. In accordance with one example embodiment, a first wireless serving communication unit (e.g. Node-B 424) supports TDD-CDMA operation on a frequency channel comprising a plurality of uplink transmission resources divided into uplink timeslots and a plurality of downlink transmission resources divided into downlink timeslots. Each RNC 436, 440 may control one or more Node-Bs 424, 426. Each SGSN 442, 444 provides a gateway to the external network 434. The Operations and Management Centre (OMC) 446 is operably connected to RNCs 436, 440 and Node-Bs 424, 426. The OMC 446 comprises processing functions (not shown) and logic functionality 452 in order to administer and manage sections of the cellular communication system 400, as is understood by those skilled in the art.

In one example embodiment, a wireless serving communication unit, such as a Node-B, comprises a transmitter that is operably coupled to a processor 496 and a timer 492. Embodiments of the invention utilize the processor 496 and timer 492 to generate a data stream for transmission in a communication system that employs a pilot scheme. The wireless communication unit, such as the Node B 424, comprises a processor arranged to: insert at least two pilots into a data payload to produce a transmit signal, wherein at least a first pilot type of the at least two pilots is different to a second pilot type of the at least two pilots. A transmitter in the Node B 424 is arranged to wirelessly transmit the transmit signal. Hereinafter, the term ‘set of pilots’ will be used in a description of pilot types ranging from one or more pilot symbols through to a more elaborate construction of a pilot, for example one that comprises a base sequence and an optional cyclic prefix. A differentiation of at least two pilots is also detailed, for example by defining a first pilot type as set ‘A’ and a second pilot type as set ‘B’.

In accordance with one example embodiment of the present invention, it is proposed that in response to the aforementioned generation of a transmit data signal for transmission that comprises at least two pilots, a receiving wireless communication unit, such as UE 414, is arranged to recover transmit data. In this regard, the wireless communication unit comprises a receiver for receiving a signal comprising a data payload and at least two pilots wherein at least a first pilot type of the at least two pilots is different to a second pilot type of the at least two pilots; and a processor arranged to extract at least one pilot of the first pilot type from the received signal; and recover the data payload from the received signal using the extracted at least one pilot of the first pilot type. In one example, the wireless communication unit performs at least two distinct channel estimation operations based on at least two different types or sets of pilot constructions.

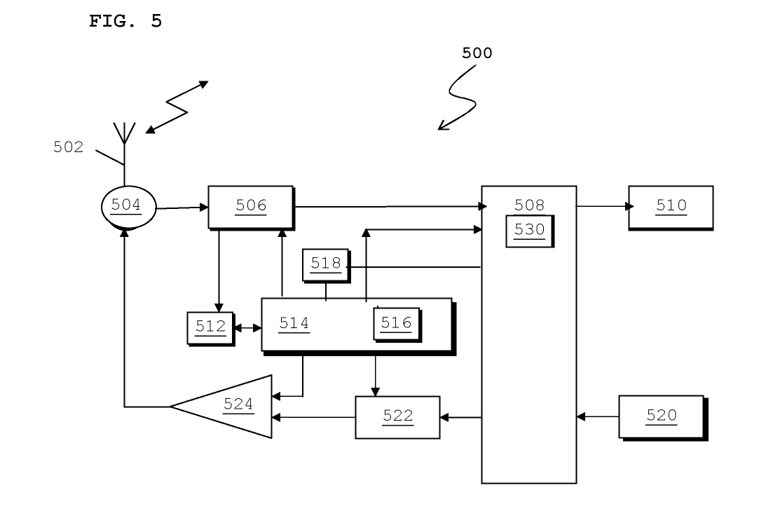

Referring now to FIG. 5, a block diagram of a wireless communication unit 500, such as UE 414 from FIG. 4 adapted in accordance with some example embodiments of the invention, is shown. In practice, purely for the purposes of explaining embodiments of the invention, the wireless communication unit is described in terms of a user equipment (UE), although similar functionality and circuitry exists in a comparable NodeB wireless communication unit. The wireless communication unit 500 contains an antenna, an antenna array 502, or a plurality of antennae, coupled to antenna switch 504 that provides isolation between receive and transmit chains within the wireless communication unit 500. One or more receiver chain(s), as known in the art, include receiver front-end circuitry 506 (effectively providing reception, filtering and intermediate or base-band frequency conversion). The receiver front-end circuitry 506 is coupled to a signal processing module 508. An output from the signal processing module 508 is provided to a suitable output device 510, such as a screen or display. The signal processing module 508 comprises baseband receiver circuitry 530 arranged to extract a hybrid pilot as hereinafter described. A skilled artisan will appreciate that the level of integration of using receiver circuits or components may be implementation-dependent.

A controller 514 maintains overall operational control of the wireless communication unit 500. The controller 514 is also coupled to the receiver front-end circuitry 506 and the signal processing module 508 (generally realised by a digital signal processor (DSP)). The controller 514 is also coupled to a memory device 516 that selectively stores operating regimes, such as decoding/encoding functions, synchronisation patterns, code sequences, and the like. A timer 518 is operably coupled to the controller 514 and the signal processing module 508 to control the timing of operations (transmission or reception of time-dependent signals) within the wireless communication unit 500.

As regards the transmit chain, this essentially includes an input device 520, such as a keypad, coupled in series through transmitter/modulation circuitry 522 and a power amplifier 524 to the antenna, antenna array 502, or plurality of antennae. The transmitter/modulation circuitry 522 and the power amplifier 524 are operationally responsive to the controller 514. The signal processor module 508 in the transmit chain may be implemented as distinct from the signal processor in the receive chain. Alternatively, a single processor may be used to implement processing of both transmit and receive signals, as shown in FIG. 5. Clearly, the various components within the wireless communication unit 500 can be realized in discrete or integrated component form, with an ultimate structure therefore being an application-specific or design selection.

In accordance with embodiments of the invention, the signal processor module 508 and/or baseband receiver circuitry 530 has/have been adapted to comprise logic (encompassing hardware, firmware and/or software) to facilitate generation of detected symbols from a received signal that utilises a hybrid pilot scheme, for example when employed over a time-varying wireless communication channel.

In one example, the hybrid pilot scheme has low pilot overhead and can, thus, be introduced with minimal changes to an existing wireless communication system originally that may have initially been designed for static or low speed channels. Examples of such wireless communication systems include TDD-CDMA and TD-SCDMA, which are evolving to cope with an increased time-varying nature of communications.

Referring now to FIG. 6, one example of a TDD-CDMA burst structure 600 employing a hybrid pilot technique is illustrated. The example TDD-CDMA burst structure 600 employing a hybrid pilot technique comprises two data fields 605, 615 that each comprise respective data symbols 625, 640 used to carry data and control channels and pilot symbols 650; a midamble sequences 610 that comprises a cyclic prefix 630 and a base sequence 635, where the midamble sequence 610 is used to provide references for channel estimation and also possibly for signalling active spreading codes. A guard period 620 is included that allows for switching between uplink (UL) and downlink (DL) transmissions.

Notably, the proposed hybrid pilot scheme consists of two different sets of pilot symbols, for example set ‘A’ comprising the midamble 610 and set ‘B’ comprising pilot symbols 650 being interspersed between the data symbols 625, 640 of the respective data fields 605, 615. In examples of the invention, set ‘B’ pilots are configured as being different to set ‘A’. In some examples, it is not necessary for the set ‘B’ pilots to have good correlation characteristics for the intended deployment scenario at each sampling point. In the simplest case, even a single known symbol may be used for the set ‘B’ pilots at each of the sampling points. In this example, three pilot symbols per data field are employed. Both sets of pilot symbols are a-priori known by the respective receiver(s). As illustrated in FIG. 6, the length of the first set pilot of pilot symbols comprising the midamble 610 is greater than the total length of the second set of pilot symbols 650. In this manner, a reduced overhead may be achieved.

In one example, the second set of pilot symbols 650 may be uniformly distributed at the symbol level amongst the data symbols in the data payload. Any distribution or pattern of the second set of pilot symbols 650 may be used, so long as the specific distribution or pattern is known at the receiver. In this manner, the second set of pilot symbols 650 may be employed to assist symbol recovery in a flat fading channel.

In one example, the pilot at the sampling point of the set ‘A’, e.g. midamble 610, is designed as a conventional pilot to provide good correlation characteristics in scenarios with, for example, multipath, multiple UEs and/or multiple transmission antennas. In one example, an optional CP 630 may be inserted if the channel is frequency selective. In one example, each set of pilot symbols may have one or multiple sampling points, with three sampling points been illustrated in this example.

In one example, the pilots at the sampling point of the set ‘B’, e.g. pilot symbols 650 being interspersed between the data symbols 625, 640 of the respective data fields 605, 615, are configured such that they do not need to have the good correlation characteristics as those for the set A. In one example, the pilot symbols 650 of set ‘B’ are configured to provide extra sampling points in addition to those of set ‘A’ e.g. midamble 610.

In one example, the TDD-CDMA burst structure 600 enables a suitably equipped receiver to track channel variations across the time period over which the signal is defined. Notably, the construction of pilot symbols within the burst structure can be configured for different operational scenarios. For example, if a duration of a transmission is reasonably short, then a single sampling point (or midamble 610 for TDD-CDMA) may be used for the first set of pilot symbols. Alternatively, a more generalized case could be employed where multiple midambles 610 are used as the first set of pilots, with additional pilot symbols 650 being inserted in between them to act as the second pilot set. In such a scenario, the first pilot set (e.g. multiple midambles 610) may also be used to track channel variation to some degree, albeit likely to be less effective than when considered in combination with the second set ‘B’ of pilot symbols 650.

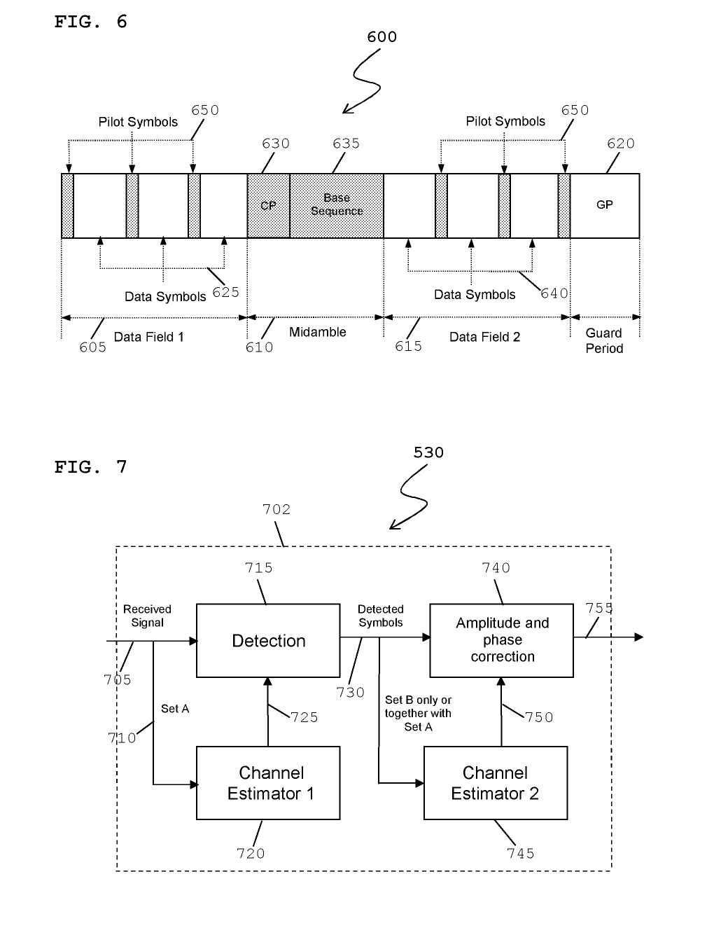

To take advantage of the above hybrid pilot scheme, a suitable receiver is also proposed in FIG. 7, where the channel estimation procedure is carried out in two stages. Referring now to FIG. 7, an example block diagram of a baseband receiver 530, utilising the example of a hybrid pilot scheme of FIG. 6, is illustrated. The baseband receiver 530 comprises two stages, in one illustrated example shown in a single integrated circuit 702. The first stage comprises detection logic 715 arranged to receive an input received signal 705. In one example, detection logic 715 may comprise a generic detector, which may be configured to perform interference suppression according to one or more of inter-symbol, inter-antenna, intra-NB and inter-UE. Thus, in various examples, the detection logic 715 may comprise an equaliser, a CDMA multi-user detector, a rake receiver, a MIMO detector, etc. Baseband receiver 530 also comprises a first channel estimator 720 that is also arranged to receive signal 705. In one example, first channel estimator 720 is arranged to perform channel estimation using the first pilot set ‘A’, for example using midamble 610 of FIG. 6. The first channel estimator 720 provides the channel estimation values 725 using the first pilot set ‘A’ to detection logic 715, so that detection logic 715 can produce detected symbols 630. In this manner, detection logic 715 may be configured, with the assistance of the first set ‘A’ of pilot symbols, to produce detected symbols 630 that compensate for multipath effects, and/or removes multi-antenna/multi-user interference, and/or compensates for dispreading effects, etc.

In the illustrated example, the detected symbols 730 that are output from detection logic 715 are input to a second stage, noting that the output symbols from detection logic 715 have the interference removed and, thus, are representative of a SISO channel. Consequently, a use of a second set ‘B’ of pilot symbols, for example using pilots 650 of FIG. 6, may be used to estimate a time-variation of the received signal, as these refined channel estimates provide better tracking accuracy. Thus, the second set ‘B’ of pilot symbols may be designed for a channel without interference, and can then be used to interpolate the equivalent channel, in contrast to the known techniques that would require the pilot to rely on good autocorrelation to remove interference.

The second stage comprises amplitude and phase correction logic 740 and a second channel estimator 745. In one example, second channel estimator 745 is arranged to perform a second channel estimation at the output of the detector based on the recovered pilots, for example using either the second set ‘B’ of pilot symbols, for example using pilots 650 of FIG. 6, or a combination of the first set ‘A’ of pilot symbols, for example using midamble 610 of FIG. 6, and the second set ‘B’ of pilot symbols, for example using pilots 650 of FIG. 6. The second channel estimator 745 provides the second channel estimation values 750 to amplitude and phase correction logic 740 in order to correct amplitude or phase variation on the samples of the output of detection logic 715 using the second channel estimates 750. The amplitude and phase correction logic 740 outputs detected and corrected symbols 755.

Thus, in one example, a shorter sequence can be used for the second pilot(s) if the pilot symbols are uniformly interleaved with the data payload, as the output from the detection logic 715 has had the interference removed, and therefore the necessity to design the set B with good correlation characteristics is negated. Consequently this reduces the pilot length at each sampling point (of set ‘B’) and hence the overall pilot overhead.

One advantage of using the modified receiver architecture of FIG. 7 is that it can be used with a pilot scheme that is a hybrid combination of two known pilot schemes that have been used individually and distinctly in the past, due to their inherent ability to assist symbol recovery in very different channel conditions. Advantageously, using the aforementioned hybrid pilot scheme, less overhead needs to be assigned for pilot symbols. As such more data may be transmitted using the pilot scheme herein described.

Furthermore, in a frequency selective channel, the first stage channel estimates using the first set ‘A’ of pilot symbols may use multiple channel estimation taps, whilst the second stage channel estimates using the second set ‘B’ of pilot symbols may only have a single channel estimation tap to be used for further phase and amplitude correction.

In one example, as described above, the first set ‘A’ of pilot symbols may also be used in the second stage channel estimation, provided that their equivalent detector output is available. In this manner, the channel estimation information that is obtainable from the first channel estimation stage can be additionally used in the second stage. For example, the effective channel seen by the second channel estimator 745 may be different to that by first channel estimator 720, and therefore re-using the first set ‘A’ of pilot symbols after detection logic 715 provides more sampling point(s) for the second channel estimator 745.

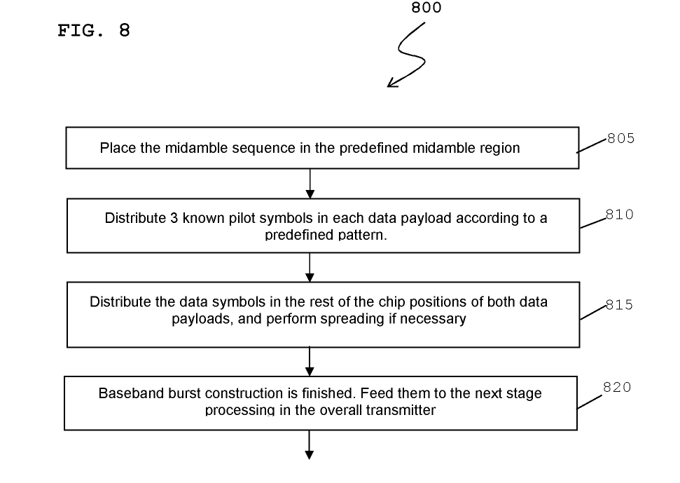

Referring now to FIG. 8, an example of a transmitter flowchart 800, for generating the example burst structure according to FIG. 6, is illustrated. The transmitter flowchart 800 commences in step 805 by placing at least one midamble sequence in at least one predefined midamble region within the burst that is known to the receiver(s). The burst is then further adapted in step 810 by distributing a number of known pilot symbols (for example three, as shown in FIG. 6) within each data payload, according to a predefined pattern that is known to the receiver(s). The burst is again further adapted in step 815 by distributing the data symbols in the remaining positions of each data payload and optionally performing spreading, if necessary, to complete the burst. For example, spreading may be added to make it more accurate for TDD-CDMA systems. Once construction of the burst has been completed, the burst is passed to the next processing stage of the transmitter to be subsequently communicated to the receiver(s).

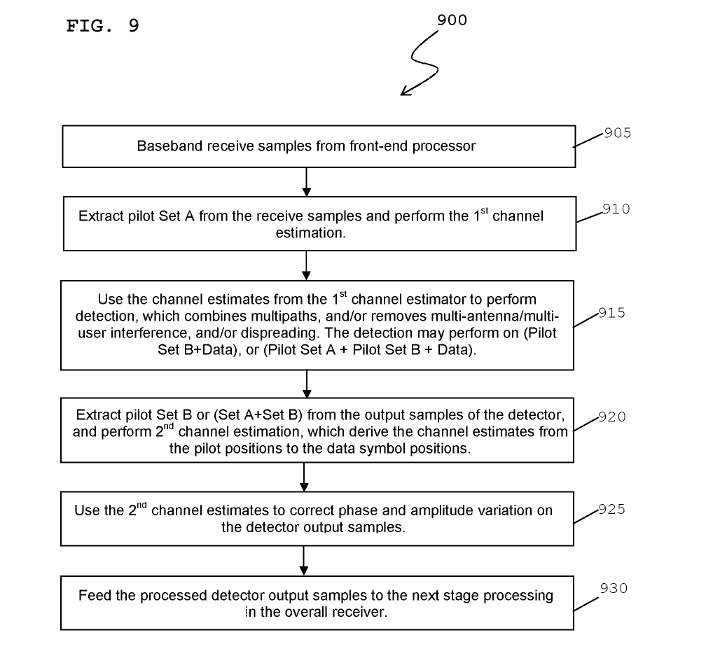

Referring now to FIG. 9, an example of a receiver flowchart 900, for extracting symbols from a received signal according to the example burst structure of FIG. 6, is illustrated. The receiver flowchart 900 commences in step 905 with the baseband circuitry receiving samples from a receiver front-end processing stage. In an optional step, the second set ‘A’ of pilot symbols may then be extracted from the received signal samples such that the input to the first channel estimator comprises the first set ‘A’ of pilot symbols in order to provide first channel estimation values, as illustrated in step 910. The channel estimates from the first channel estimator are then used to perform detection of the received signal, for example combining multipaths, removing multi-antenna effects, removing multiple user interference, performing de-spreading, etc. The detection performed using the first channel estimates may be applied on the second pilot set ‘B’ and the data or on both the first and second pilot sets ‘A’ and ‘B’ as well as the data, as shown in step 915. The output from the first channel estimator is a recovered stream of detected symbols.

The recovered stream of detected symbols, output from the detector, is input to a second channel estimator, which in one example is arranged to derive channel estimates from the relative positions of the pilot positions to the data symbols, as shown in step 920. The derived channel estimates received from the second channel estimator are then used in correction logic to correct any phase and/or amplitude variation on the detector output samples, as in step 920. The output samples from the correction logic are then fed to subsequent receiver processing stages, as shown in step 925.

Although one example embodiment of the invention describes the inventive concept as applied to a UMTS™, TD-CDMA communication system, it is envisaged that the inventive concept is not restricted to this application or embodiment. In particular, for example, future evolutions of UTRA 3GPP™ (currently referred to as ‘long term evolution’ (LTE)) and utilise pilots will also be divided into timeslots (or other such named time portions), and will therefore be able to benefit from the concepts described hereinbefore. In current LTE, as illustrated in FIG. 10, one LTE sub-frame consists of two 0.5 msec slots 1005, supporting a normal cyclic prefix (CP) 1010 and (PUSCH) physical uplink shared channel carrying data 1015. The LTE uplink uses single-carrier frequency domain multiple access (SC-FDMA) modulation. In one slot, there are seven and six SC-FDMA symbols for normal and extended cyclic prefixes, respectively. Each SC-FDMA symbol has an integer multiple of twelve symbols, which is used to carry either pilot(s) or data. Pilot transmission in a slot is concentrated at the pilot SC-FDMA symbol in a middle region for a PUSCH slot, as shown. Similar to the midamble in TDD-CDMA, the pilot sequence inside the pilot SC-FDMA symbol may be designed with good correlation properties under frequency selective channels. The known LTE PUSCH slot in FIG. 10 may be improved for high speed operation under fast fading conditions by using intra-subframe channel estimation between two pilot SC-FDMA symbols within the subframe. However, this is not always available since they may not be transmitted at the same frequency region when UL frequency hopping is enabled. Even when it is available, the large time spacing (of an order of 0.5 msec) between these two pilots would become the limiting factor.

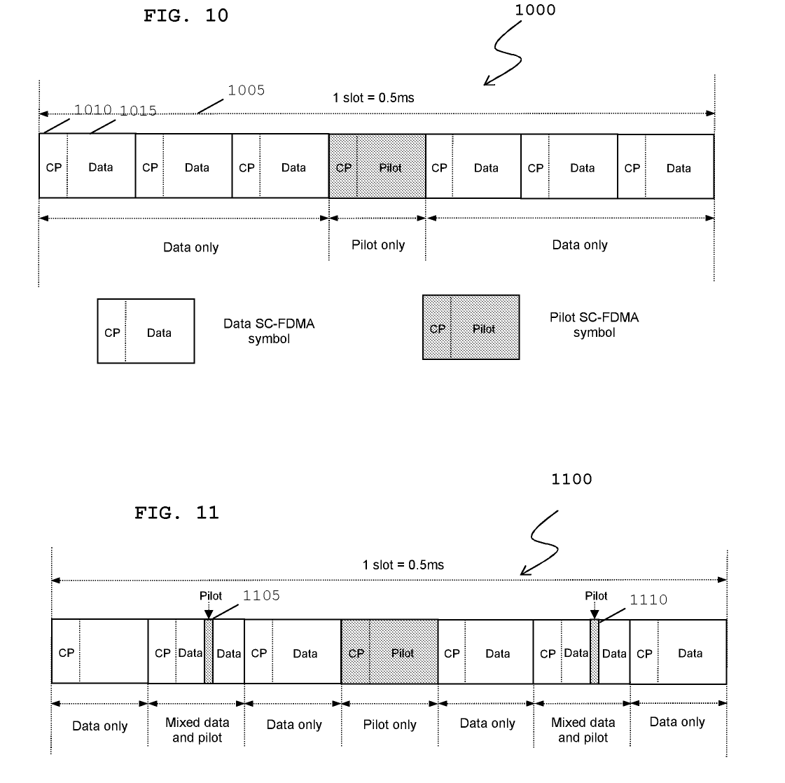

FIG. 11 illustrates an example of an extended LTE slot structure 1100 employing one example of a proposed pilot technique. In this example, only two pilot symbols (as the set ‘B’) 1105, 1110 are inserted in the second and second last data SC-FDMA symbols and therefore the overall pilot overhead is increased marginally. A receiver structure similar to that in FIG. 7 is able to exploit the benefits provided by the hybrid pilot scheme. This is due to the fact that the two extra pilot symbols on their own may not be sufficient to cope with frequency-selective or multiple user channels, so a combination of using both set ‘A’ and set ‘B’ in the second channel estimator may be employed in one example.

In a further example, the TDD-CDMA burst or LTE PUSCH slot, as improved by the aforementioned pilot scheme, may be deployed in an adaptive manner for optimal results. When the original pilot alone is sufficient to cope with the channel speed, the original burst/slot (e.g. set ‘A’ alone) may be used with minimum pilot overhead. When the original pilot alone is not sufficient to cope with the channel speed, the hybrid pilot (e.g. set ‘A’+set ‘B’) may then be enabled to improve high-speed performance. The mode adaptation may be determined by utilising measurements or feedback of the channel time-variations, or any other suitable scheme.

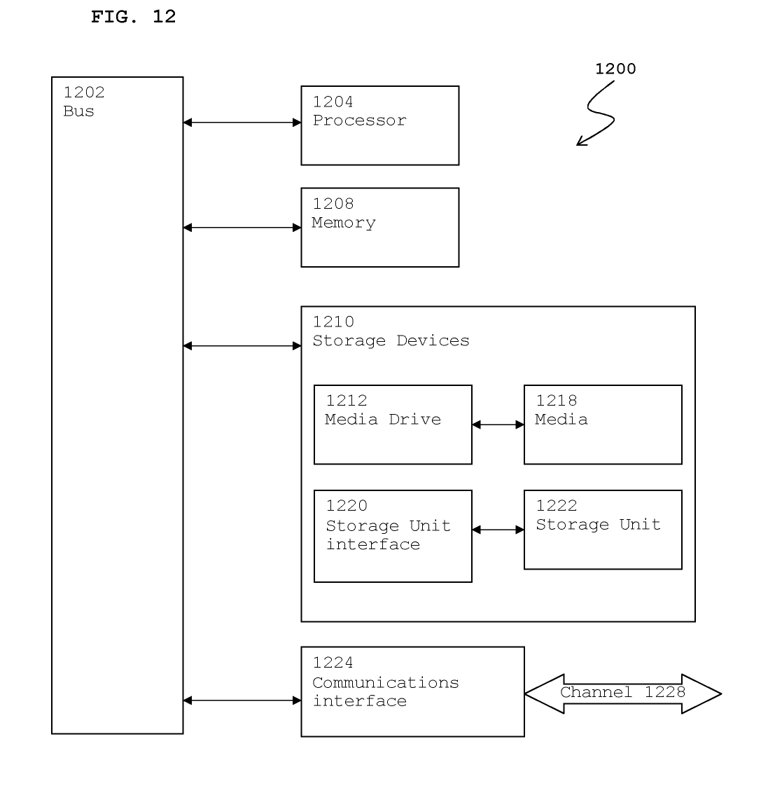

FIG. 12 illustrates a typical computing system 1200 that may be employed to implement processing functionality in embodiments of the invention. Computing systems of this type may be used in a network controller or other network element (which may be an integrated device, such as a mobile phone or a USB/PCMCIA modem), for example. Those skilled in the relevant art will also recognize how to implement the invention using other computer systems or architectures. Computing system 1200 may represent, for example, a desktop, laptop or notebook computer, hand-held computing device (PDA, cell phone, palmtop, etc.), mainframe, server, client, or any other type of special or general purpose computing device as may be desirable or appropriate for a given application or environment. Computing system 1200 can include one or more processors, such as a processor 1204. Processor 1204 can be implemented using a general or special purpose processing engine such as, for example, a microprocessor, microcontroller or other control logic. In this example, processor 1204 is connected to a bus 1202 or other communications medium.

Computing system 1200 can also include a main memory 1208, such as random access memory (RAM) or other dynamic memory, for storing information and instructions to be executed by processor 1204. Main memory 1208 also may be used for storing temporary variables or other intermediate information during execution of instructions to be executed by processor 1204. Computing system 1200 may likewise include a read only memory (ROM) or other static storage device coupled to bus 1202 for storing static information and instructions for processor 1204.

The computing system 1200 may also include information storage system 1210, which may include, for example, a media drive 1212 and a removable storage interface 1220. The media drive 1212 may include a drive or other mechanism to support fixed or removable storage media, such as a hard disk drive, a floppy disk drive, a magnetic tape drive, an optical disk drive, a compact disc (CD) or digital video drive (DVD) read or read-write drive (R or RW), or other removable or fixed media drive. Storage media 1218 may include, for example, a hard disk, floppy disk, magnetic tape, optical disk, CD or DVD, or other fixed or removable medium that is read by and written to by media drive 1214. As these examples illustrate, the storage media 1218 may include a computer-readable storage medium having stored therein particular computer software or data.

In alternative embodiments, information storage system 1210 may include other similar components for allowing computer programs or other instructions or data to be loaded into computing system 1200. Such components may include, for example, a removable storage unit 1222 and an interface 1220, such as a program cartridge and cartridge interface, a removable memory (for example, a flash memory or other removable memory module) and memory slot, and other removable storage units 1222 and interfaces 1220 that allow software and data to be transferred from the removable storage unit 1218 to computing system 1200.

Computing system 1200 can also include a communications interface 1224. Communications interface 1224 can be used to allow software and data to be transferred between computing system 1200 and external devices. Examples of communications interface 1224 can include a modem, a network interface (such as an Ethernet or other NIC card), a communications port (such as for example, a universal serial bus (USB) port), a PCMCIA slot and card, etc. Software and data transferred via communications interface 1224 are in the form of signals which can be electronic, electromagnetic, and optical or other signals capable of being received by communications interface 1224. These signals are provided to communications interface 1224 via a channel 1228. This channel 1228 may carry signals and may be implemented using a wireless medium, wire or cable, fiber optics, or other communications medium. Some examples of a channel include a phone line, a cellular phone link, an RF link, a network interface, a local or wide area network, and other communications channels.

Those skilled in the art will recognize that the boundaries between logic blocks are merely illustrative and that alternative embodiments may merge logic blocks or circuit elements or impose an alternate composition of functionality upon various logic blocks or circuit elements. Thus, it is to be understood that the architectures depicted herein are merely exemplary, and that in fact many other architectures can be implemented which achieve the same functionality. For example, in the example illustrated in FIG. 7, the first and second channel estimators are illustrated as separate functional elements. However, it will be appreciated that first and second channel estimators may alternatively form an integral part of receiver processing circuitry, such as the processing logic 508 illustrated in FIG. 5.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one example embodiment, the illustrated examples may be implemented as circuitry located on a single integrated circuit or within a same device, such as illustrated in FIG. 5 or FIG. 7. Alternatively, the examples may be implemented as any number of separate integrated circuits or separate devices interconnected with each other in a suitable manner.

It will be appreciated that, for clarity purposes, the above description has described embodiments of the invention with reference to different functional units and processors. However, it will be apparent that any suitable distribution of functionality between different functional units or processors, for example with respect to the baseband receiver logic or channel estimators or detection logic or phase/amplitude correction logic, may be used without detracting from the invention. For example, functionality illustrated to be performed by separate processors or controllers may be performed by the same processor or logic. Hence, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as field programmable gate array (FPGA) devices. Thus, the elements and components of an example embodiment of the invention may be physically, functionally and logically implemented in any suitable way. Indeed, the functionality may be implemented in a single unit, in a plurality of units or as part of other functional units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to “a”, “an”, “first”, “second” etc. do not preclude a plurality.

1.-22. (canceled)

23. A wireless communication unit configured to recover transmitted data, the wireless communication unit comprising:
a receiver configured to receive a signal comprising a data payload and at least two pilots wherein at least a first pilot type of the at least two pilots is different to a second pilot type of the at least two pilots; and
a processor configured to extract at least one pilot of the first pilot type from the received signal; and
the processor configured to recover the data payload from the received signal using the extracted at least one pilot of the first pilot type.

24. The wireless communication unit of claim 23 wherein the processor is further configured to:
extract at least one pilot of the second pilot type from the received signal; and
recover the data payload from the received signal using the extracted at least one pilot of the first pilot type and the extracted at least one pilot of the second pilot type.

25. The wireless communication unit of claim 23 further comprising:
a first channel estimator configured to perform first channel estimation on the received signal using the at least one pilot of the first pilot type to produce a first recovered stream that comprises at least the data payload and at least one pilot of the second pilot type.

26. The wireless communication unit of claim 25 wherein the receiver further comprises detector logic coupled to the first channel estimator and configured to detect symbols of the received signal using first channel estimates received from first channel estimator to produce the first recovered stream.

27. The wireless communication unit of claim 25 further comprising:
a second channel estimator configured to perform second channel estimation on the first recovered stream using at least one pilot of the second pilot type to produce recovered data.

28. The wireless communication unit of claim 27 wherein the first recovered stream comprises at least one pilot of the first pilot type such that the second channel estimator is configured to perform second channel estimation on the first recovered stream using the at least one pilot of the first pilot type; and
the at least one pilot of the second pilot type to produce recovered data.

29. The wireless communication unit of claim 27 further comprising:
circuitry configured to correct amplitude of symbols in the first recovered stream using second channel estimates received from second channel estimator; or
configured to correct phase of symbols in the first recovered stream using second channel estimates received from second channel estimator.

30. The wireless communication unit of claim 24 wherein the at least one pilot of the second pilot type is used by the processor to estimate a time-variation of the received signal.

31. The wireless communication unit of claim 24 wherein the at least one pilot of the second pilot type comprises a number of pilot symbols interspersed between data in a data field.

32. The wireless communication unit of claim 24 wherein the at least one pilot of the second pilot type comprises a number of pilot symbols interspersed between data in a data field.

33. The wireless communication unit of claim 24 wherein the at least one pilot of the second pilot type is extracted to compensate for an effect of a flat fading channel.

34. The wireless communication unit of claim 24 wherein the at least one pilot of the second pilot type provides at least one additional sampling point to the at least one pilot of the first pilot type.

35. The wireless communication unit of claim 34 wherein the at least one pilot of the second pilot type is located at a sampling point such that the at least one pilot of the second pilot type does not exhibit a good correlation characteristic required by a target deployment scenario of the wireless communication unit.

36. The wireless communication unit of claim 23 wherein, for each sampling point, a duration of the at least one pilot of the first pilot type is greater than a duration of the at least one pilot of the second pilot type.

37. A method to recover transmit data in a wireless communication unit, wherein the method comprising:
receiving, by the wireless communication unit, a signal comprising a data payload and at least two pilots wherein at least a first pilot type is different to a second pilot type; and
extracting, by the wireless communication unit, at least one pilot of the first pilot type from the received signal; and
recovering, by the wireless communication unit, the data payload from the received signal using the extracted at least one pilot of the first pilot type.

38. A wireless communication unit configured to transmit data, the wireless communication unit comprising:
a transmitter configured to send a signal comprising a data payload and at least two pilots wherein at least a first pilot type of the at least two pilots is different to a second pilot type of the at least two pilots; and
wherein the at least one pilot of the first pilot type is extracted from the transmitted signal; and
wherein data payload from the received signal is recovered using the extracted at least one pilot of the first pilot type.
